(19) United States
(12) Patent Application Publication
(10) Pub. No.: US 2007/0194883 A1
(43) Pub. Date: Aug. 23, 2007

(54) SECURITY SYSTEM FOR FURNITURE

(76) Inventor: John Currie, Livonia, MI (US)

Correspondence Address: Dickinson Wright PLLC, 38525 Woodward Avenue, Suite 2000, Bloomfield Hills, MI, 48304, US

(21) Appl. No.: 11/307,450

(22) Filed: Feb. 8, 2006

(51) Int. Cl. G05B 19/00

(52) U.S. Cl. 340/5.62; 340/5.61; 340/5.73; 340/5.64

(57) ABSTRACT

A security system for use with furniture includes a controller, an actuator and a communication device. The controller is for querying a first signal, receiving a second signal and commanding an unlock actuation signal or a lock actuation signal. The actuator receives the actuation signal. The communication device is for transmitting the first signal received from the controller and receiving the second signal in response to transmitting the first signal, wherein the controller sends the unlock actuation signal in response to verifying that the second signal is indicative of the first signal being properly verified by a closely located verifying device. A security system that listens for a beaconing device is also provided. A method of operating a security system for use with furniture is also included.

### TECHNICAL FIELD

The present invention relates generally to a security system for lockable enclosures, and more particularly to a proximity system for securing lockable elements of furniture.

### BACKGROUND

Furniture used in healthcare, office and security environments typically include shelves, cabinets, drawers and other enclosures that, when necessary, may include security type elements to prevent unauthorized access.

Furniture may typically employ various mechanisms that reduce the likelihood of theft by unauthorized access to the contents within the piece of furniture. This “security-type function” is realized by mechanisms including a traditional mechanical lock and key or an electrically activated actuator that includes an electronic keypad or remote, both of which require entry of a code by a person, i.e., such as depressing a key on a wireless fob or by entering a code on a keypad. While these mechanisms prevent unauthorized access to the contents, they are inconvenient to use at times and suffer some drawbacks.

For example, a user may find it inconvenient to constantly lock and unlock using mechanical keys each time access to the contents is desired, and so he may choose to leave the piece unlocked and the contents unsecured. One such user could be an office worker who unlocks his office furniture only when he arrives at work in the morning, then leaves the contents unsecured during the day as he comes and goes from the vicinity, and relocks his office furniture only when he leaves work in the evening. In this situation, security is compromised in favor of a greater level of convenience when frequent access to furniture contents is anticipated. In the case of the electronic keypad, the user may find it inconvenient to memorize a specific code or inconvenient to type this code before each access. Also, allowing someone temporary access to the furniture contents is complicated by the need to disclose the pass code. With a fob, the user is required to have a free hand accessible in order to depress an access button or to enter a security code. Accordingly, it is desirable to secure furniture more conveniently without requiring the use of a mechanical key, the need to memorize or enter a pass code, or the need to manually activate a fob.

It would be advantageous to have a security system for furniture that overcomes the limitations indicated above. An inventive security system is better suited for securing lockable elements of furniture in an efficient and substantially hands-free manner, thereby providing a timesaving accessibility and security assurance without having to compromise convenience.

### SUMMARY OF THE INVENTION

Accordingly, the present invention provides a security system for use with furniture. The inventive security system advantageously secures lockable elements of furniture in an efficient and substantially hands-free manner by providing timesaving accessibility and improved security assurance without having to compromise convenience.

The security system includes a controller, an actuator and a communication device. The controller is for querying a first signal, receiving a second signal and commanding an unlock actuation signal or a lock actuation signal. The actuator receives the actuation signal. The communication device is for transmitting the first signal received from the controller and receiving the second signal in response to transmitting the first signal, wherein the controller sends the unlock actuation signal in response to verifying that the second signal is indicative of the first signal being properly verified by a closely located verifying device.

A security system that listens for a beaconing device is also provided.

A method of operating a controller of a security system for use with furniture is also included.

Generally, the present invention provides in one aspect a security system for furniture comprising one or more locks which may be engaged or disengaged under electronic control by locking actuators, one or more devices for sensing user access attempts, a user-wearable means of communication with the system, a controller for controlling the system, and a method for operating the security system in a keyless and hands-free manner.

Thus, an advantage of the present invention is to provide a novel security system for securing shelves, drawers, cabinets, chests, and other lockable elements associated with furniture, which obviates the need to use a mechanical key or type a pass code.

A further advantage of the invention is to provide a “hands-free” system for conveniently securing shelves, drawers, cabinets, chests, and other lockable elements of furniture.

The present invention has advantages by providing a security system for use with furniture. The present invention itself, together with further intended advantages, will be best understood by reference to the following detailed description and taken in conjunction with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows a block diagram of a security system according to the present invention.

FIG. 2A shows a flow chart illustrating a sequence of steps according to a first embodiment of the security system controller in accordance with the present invention.

FIG. 2B shows a flow chart illustrating a sequence of steps according to a second embodiment of the security system controller in accordance with the present invention.

FIG. 3 shows a flow chart illustrating a sequence of steps according to a verifying device in accordance with the present invention.

FIG. 4 shows a view of an office cubicle wherein the present invention may be used to advantage.

### DETAILED DESCRIPTION

In the following description, various operating parameters and components are described for one or more constructed embodiments. These specific parameters and components are included as examples and are not meant to be limiting.

While the invention is described with respect to a security system for selectively securing enclosures within an office cubical, the following system is capable of being adapted for various enclosure security systems including storage cabinets, drawers, enclosed shelves, tool cabinets or storage containers wherein a substantially hands-free activation is desirable and secured access is controlled.

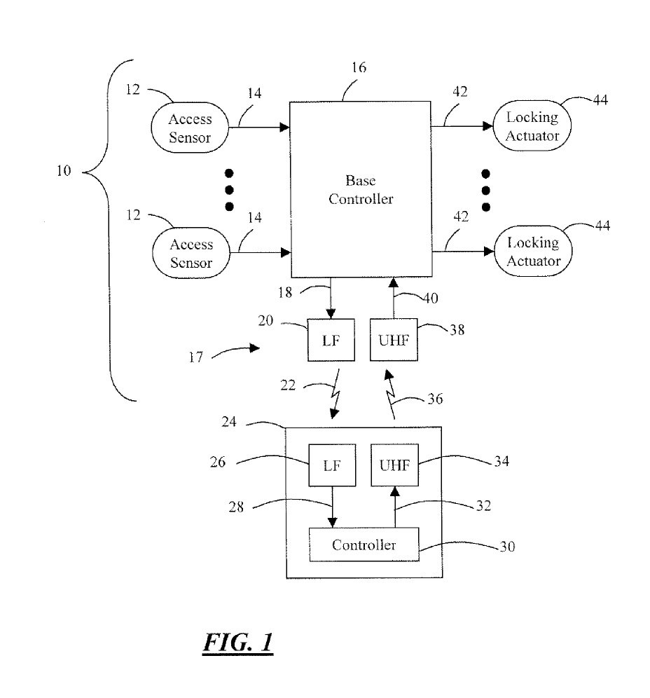

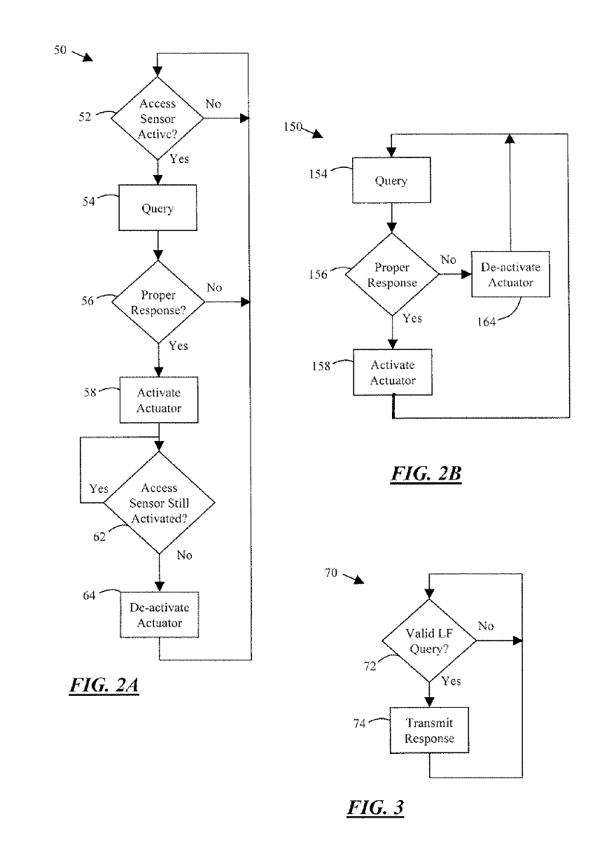

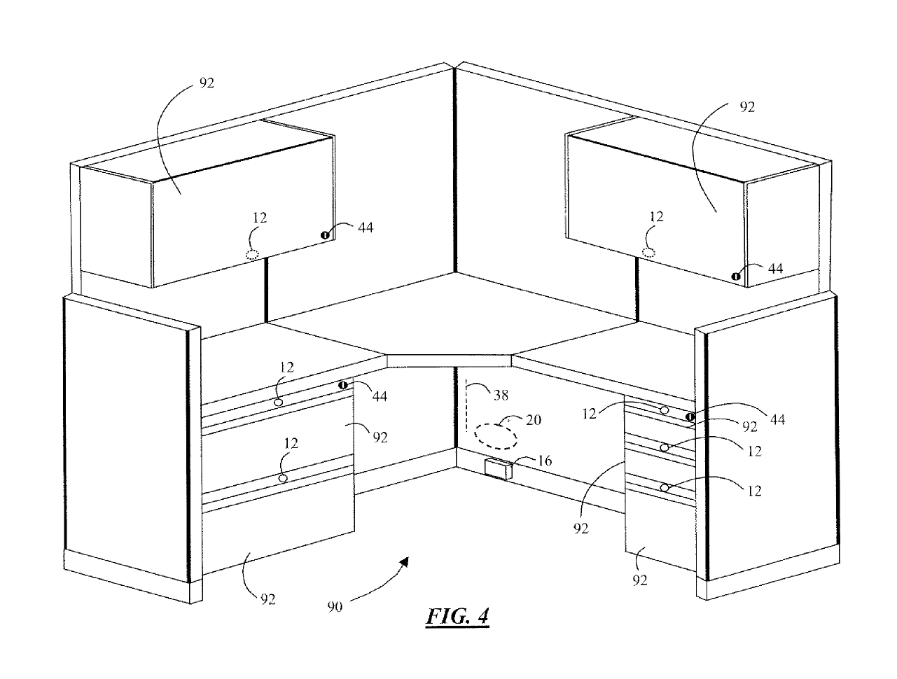

FIG. 1 shows a block diagram of a security system 10 according to the present invention. The operation of the security system 10 will be discussed in conjunction with the flow chart 50 of FIG. 2A. Returning to FIG. 1, the security system 10 is intended to be utilized together with a verifying device 24 for determining when substantially hands-free access is allowed or denied to an enclosure 92 (see FIG. 4). The security system 10 includes a controller 16, a mechanism or locking actuator 44, and a communication device 17. The security system 10 may optionally include an access sensor 12 for use to advantage with the present invention.

The base or controller 16 queries for the presence of a verifying device 24 by sending a query signal or message through the communication device 17. The controller 16 may continually prompt a query signal or periodically send a query signal. Also, the controller 16 may prompt a query signal when triggered by an external sensor, such as an access sensor 12. The communication device 17 then transmits the message wirelessly and waits for a return signal to communicate back to the controller 16. The base controller 16 receives the return signal for verification, and then if the return signal is a proper response to the query signal, the controller 16 activates an appropriate locking actuator 44, thereby unlocking the appropriate enclosure 92 and allowing user access to the contents. Optionally, the locking actuator 44 can include a manual override for locking or unlocking the enclosure 92 manually, such as with a mechanical lock and key, thereby allowing the furniture to be accessed conventionally.

Also, the controller 16 includes a logic circuit such as a processor, a power supply and memory, thereby allowing the controller to receive and transmit signals in accordance with the present invention.

The locking actuator 44 receives a controlling signal for activating or deactivating from the controller 16 over communication path 42. The activation signal unlocks the enclosure 92, whereas the deactivation signal locks the enclosure 92. There may be multiple numbers of locking actuator 44 for locking and unlocking multiple numbers of enclosures 92. Optionally, one actuator may unlock or lock multiple enclosures 92 at the same time.

The communication device 17 includes communication links 18, 40, a transmitter 20 for sending low frequency signal 22, and a receiver 38 for receiving signal 36. Optionally, the transmitter 20 and the receiver 38 may be combined into a transceiver. The communication link 18 passes the message to the transmitter 20 for transmission to the airwaves as a low frequency (LF) signal 22. The LF signal is designed for close proximity transmission, such that if the verifying device 24 is within transmission range, the verifying device may provide a response or receiving signal 36 back to the receiver 38. The LF signal 22 may be chosen so that sufficient transmission strength is maintained for about two meters from the transmitter 20. It is recognized that the LF signal 22 may be chosen for other or more convenient distances in accordance with the present invention. The response or receiving signal 36, as transmitted by the verifying device 24 back to the security system 10 in response to the LF signal 22, may be any frequency suitable for the present invention and may include ultra high frequencies (UHF). The receiver 38 receives the receiving signal 36 and transmits the signal to the controller 16 by way of the communication link 40.

The switch or access sensor 12 may be used to advantage with the present invention for triggering the controller 16 to send a query signal or message. The access sensor 12 is activated when the user attempts to open the enclosure 92. The access sensor 12 communicates the user's intention to open the locked furniture element to a base controller 16 over a communication link 14. This access sensor 12 may be integrated into the enclosure in such a way as to make unlocking of the enclosure 92 by the actuator 44 unnoticeable or with little delay thereby providing a nearly simultaneous access to the enclosure as would be expected by a user for an enclosure that is otherwise unlocked. The access sensor may be any sensor type including, without limitation, an optical sensor, a pressure sensor, a position sensor or a mechanical switch.

A verifying device 24 may be utilized with the security system 10 to advantage thereby allowing determination of when substantially hands-free access is allowed or denied to an enclosure 92. The verifying device 24 includes an LF receiver 26 which may receive signal 22 containing a message from a transmitter 20. The message is then transferred from the receiver 26 to a verifier or controller 30 over a communication link 28. If the controller 30 received a proper query message, it responds with a message over communication link 32 to a transmitter 34, which then broadcasts the response message by way of a response or receiving signal 36. The transmitter 34 may be a UHF transmitter. Also, the receiver 26 and the transmitter 34 may be an active transceiver. Also, the verifying device 24 may be a passive type of element such as tag type of device. The verifying device 24 is utilized to qualify when access is to be granted into an enclosure without necessarily requiring the user to hold the verifying device 24 in his hand.

Also, the verifying device 24 may include a logic circuit or a processor, a power supply and memory, thereby allowing the verifying device 24 to receive and transmit signals in accordance with the present invention.

FIG. 2A shows a flow chart 50 illustrating a sequence of steps according to a first embodiment of the security system controller 16 in accordance with the present invention.

The flow chart 50 begins with decision step 52 in which the controller 16 determines if a user is currently attempting to access an enclosure 92. If access sensor 12 is active, the controller 16 executes step 54, otherwise the controller 16 continues to monitor the sensor 12 by re-executing step 52. In step 54, the controller 16 cooperates with the communication device 17 to send a query signal or message to the verifying device 24. The methodology then proceeds to decision step 56.

In decision step 56, the controller 16 cooperates with the communication device 17 in checking for a proper response from the verifying device 24. If no response is received, or if an improper response is received, then the methodology returns to decision step 52. Otherwise, if the controller 16 determines that a proper response to the query was received, then the methodology proceeds to step 58.

In step 58, the controller 16 cooperates with the appropriate locking actuator 44 to unlock the enclosure 92 and thereby allow user access to the contents.

In decision step 62, the controller 16 waits for the user to stop activating the access sensor 12. When the base controller 16 detects that the access sensor 12 is no longer active, the methodology 50 proceeds to step 64, in which the controller 16 cooperates with the locking actuator 44 to re-secure or lock the enclosure 92. The methodology 50 then returns to decision step 52 to await another user access attempt.

FIG. 2B shows a flow chart 150 illustrating a sequence of steps according to a second embodiment of the security system controller 16 in accordance with the present invention. The flow chart 150 begins with step 154; the controller 16 cooperates with the communication device 17 to send a query signal or message to the verifying device 24. The methodology then proceeds to decision step 156.

In decision step 156, the controller 16 cooperates with the communication device 17 in checking for a proper response from the verifying device 24. If no response is received, or if an improper response is received, then the methodology proceeds to decision step 164. Otherwise, if the controller 16 determines that a proper response to the query was received, then the methodology proceeds to step 158.

In step 158, the controller 16 cooperates with the locking actuators 44 to unlock the enclosures 92 and thereby allow user access to the contents.

In step 164, the controller 16 cooperates with the locking actuators 44 to lock the enclosures 92 and thereby denying user access to the contents.

Upon completing step 158 or 164 the methodology 150 then returns to decision step 154.

One of skill in the art will recognize that iteration rate control or filtering of queries or responses may be employed to advantage in some embodiments.

FIG. 3 shows a flow chart 70 illustrating a sequence of steps according to a verifying device 24 in accordance with the present invention. The flow chart 70 begins with decision step 72 in which the controller 30 of the verifying device 24 determines if it has properly received a query signal or message from the security system 10. If the message is indicative of a security system corresponding, coded or belonging with this verifying device 24, then step 74 executes. Otherwise, the methodology 70 returns to decision step 72. In step 74, the controller 30 cooperates with the transmitter 34 to broadcast a response or receiving signal 36. Then the methodology 70 returns to decision step 72.

FIG. 4 shows a view of an office cubicle 90 wherein the present invention may be used to advantage. The workstation or office cubicle 90 shows an example placement of various components of a security system 10 and a variety of enclosures 92. The enclosures 92 may include, without limitation, drawers, file cabinets, and bookshelves. One of skill in the art will recognize that many different component placements and installations are possible.

Returning to FIG. 1, generally, the security system 10 may query and receive a response sequence triggered from the activation of an access sensor. In addition, the security system 10 may continuously, or periodically, query or poll for a verification device.

In addition, the security system 10 may listen for a verification device 24. In this aspect, the verification device 24 provides beaconing signals. This way, the security system 10 may initiate query or message in response to receiving a signal coming from the beaconing device. By acting as a receiver for the beaconing signal, the security system 10 does not necessarily need to send queries triggered by the beaconing signal, i.e., the security system 10 listens for when the verification device 24 comes in range, and controls the locks accordingly. It is recognized that when the verification device acts as a beacon, its power source or battery may drain at a faster rate, which is of minor concern when the verification device 24 is utilized as an embedded function within a cell phone or other consumer device being regularly charged anyway. In accord, the security system 10 may initiate step 56, 156 in the flow chart 50, 150 of FIGS. 2A or 2B, respectively, upon receipt of the beaconing signal in order to verify the action to be taken.

It is noted that the operation of security system 10 is substantially transparent to the user. That is, if the user has a verifying device 24 in near proximity to a locked enclosure 92, then the locked enclosure 92 will automatically unlock upon or prior to an access attempt without further action required of the user. Thus, this security system provides a highly convenient means for a user to control access to lockable enclosures 92 without requiring the use of a mechanical key or the typing of a pass code. It should be understood that many variations of the illustrated embodiment are possible, including various integrations or separations of the components. For example, the verifying device 24 may take a variety of physical and functional forms, and may be integrated into devices such as cell phones, personal digital assistants (PDA's), identification badges or cards, etc. The verifying device 24 and the communications device 17 may employ a variety of communication schemes, including utilizing a variety of suitable RF frequencies. Also, it is recognized that the controller 16 may continuously poll for the presence of the verifying device 24. Moreover, the verifying device 24 may continuously send a beacon to indicate its presence to the controller 16. Lastly, the verifying device 24 and the controller 16 may use any of a variety of encryption schemes for security as would be understood to a person of skill in the art. The teachings of this invention are easily adapted and applied to furniture having one or more lockable elements or containers. For example, the security system 10 may be readily adapted to single, stand-alone cabinets or other lockable pieces of furniture, as well as to related groupings of lockable elements such as in the illustrated embodiments.

From the foregoing, it can be seen that there has been brought to the art a new and improved security system for furniture. While the invention has been described in connection with one or more embodiments, it should be understood that the invention is not limited to those embodiments. On the contrary, the invention covers all alternatives, modifications, and equivalents as may be included within the spirit and scope of the appended claims.

What is claimed is:

1. A security system for use with furniture comprising:
a controller for receiving a second signal and commanding an actuation signal;
one or more actuators for receiving said actuation signal; and
a communication device for receiving said second signal,
wherein said controller sends said actuation signal in response to verifying that said second signal is indicative of an authorized closely located verifying device.

2. The security system of claim 1, wherein said controller for querying a first signal, and said communication device for transmitting said first signal received from said controller, wherein said controller sends said actuation signal in response to verifying that said second signal is indicative of an authorized closely located verifying device having received said first signal.

3. The security system of claim 2 wherein said actuation signal is an unlock actuation signal.

4. The security system of claim 2, wherein said actuation signal is a lock actuation signal when said second signal is not received.

5. The security system of claim 4, wherein said controller sends said lock actuation signal when said second signal is not verified.

6. The security system of claim 2, wherein said actuation signal is a lock actuation signal when said second signal is not indicative of said first signal being properly verified by a closely located verifying device.

7. The security system of claim 2, wherein said verifying device must be within a predetermined range in order for said second signal to be indicative of said first signal.

8. The security system of claim 7, wherein said predetermined range is about 2 meters.

9. The security system of claim 2, wherein said communication device includes a low frequency transmitter for transmitting said first signal.

10. The security system of claim 1, wherein said communication device includes a high frequency receiver for receiving said second signal.

11. The security system of claim 1 further comprising a manual override or keyed lock for unlocking said actuator.

12. The security system of claim 2 further comprising one or more access sensors having a sensor signal, wherein said controller initiates said first signal in response to said sensor signal being indicative of an access attempt by a user.

13. The security system of claim 2, wherein said controller utilizes encryption for said signals.

14. The security system of claim 1 further comprising a verifying device having a verifying controller for commanding a second signal and a transmitter for transmitting said second signal.

15. The security system of claim 14, wherein said verifying device includes a low frequency receiver for receiving a first signal when said verifying device is in close proximity to said communication device, wherein said verifying controller qualifies said first signal when received and transmits said second signal, wherein said verifying device is adapted for user wear and provides hand-free activation of said actuator when closely located to said communication device.

16. A method of operating a security system for use with furniture comprising in a controller:
determining if an access sensor is activated;
querying a verification device with a first signal when said access sensor is active;
determining and verifying if a second signal is received from said verification device; and
commanding an unlock actuation signal to an actuator when said second signal is indicative of an authorized closely located verifying device having received said first signal.

17. The method of claim 16 further comprising determining if an access sensor is deactivated and commanding a lock actuation signal when said access sensor is deactivated.

18. A method of operating a security system for use with an enclosure comprising in a controller:
querying a verification device with a first signal;
determining and verifying when a second signal is received from said verification device;
commanding an unlock actuation signal to an actuator when said second signal is indicative of an authorized closely located verifying device having received said first signal; and
repeating the steps of querying, determining and commanding.

19. The method of claim 18 further comprising querying to determine if said verification device is within a predetermined range and commanding a lock actuation signal when said verification device is not in the predetermined range.

20. The method of claim 18, wherein querying is by transmitting said first signal at a low frequency.
